(19) United States
(12) Patent Application Publication
(10) Pub. No.: US 2007/0051325 A1
(43) Pub. Date: Mar. 8, 2007

(54) Veterinary apparatus and method of use

(76) Inventor: David John Michael Gibson, Wellington (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/563,735

(22) PCT Filed: Jul. 7, 2004
(86) PCT No.: PCT/NZ04/00144

§ 371 Date: Sep. 18, 2006

(30) Foreign Application Priority Data
Jul. 7, 2003 (NZ) 526881
Aug. 5, 2003 (NZ) 527409
Jan. 21, 2004 (NZ) 530720

(51) Int. Cl. A01K 21/00

(52) U.S. Cl. 119/854

(57) ABSTRACT

An apparatus for positioning an item in or near a natural orifice of a non-human animal, includes at least one resilient rod (2) having a first portion adapted to the shape of part of the animal's body spaced from the orifice and a second portion adapted to extend to or beyond the part of the animal's body in the region of the orifice. An achoring arrangement 1 anchors the rod(s) (2) to the part of the animal's body spaced from the orifice. A transverse cross member (4) is adapted in use to be biased into contact with the animal's body in the region of the natural orifice as a result of the resilience of the rod(s) (2).

### FIELD OF THE INVENTION

The present invention relates to an apparatus for positioning an item in or near a natural orifice of a non-human animal.

### BACKGROUND OF THE INVENTION

The delivery or collection of substances to or from living non-human animals has commonly involved injections or devices requiring surgical implantation or retention within a natural body cavity, for example the rumen or the vagina. The administration of substances by injection often causes abscesses and high levels of the substances are frequently found at the injection site at slaughter. Injections also can damage the hide and are therefore restricted to particular sites, e.g. to the neck region. Many drugs do not achieve their maximum therapeutic action through conventional injection techniques. The therapeutic action of such drugs is improved considerably when delivered at a controlled rate to maintain optimum drug concentration for a specific period. In a typical drug injection, a greater drug concentration than necessary must be administered to keep the drug concentration within the effective therapeutic margin for the minimum period necessary for treatment. With controlled drug infusion, the drug can be given at a precise rate that will keep the drug serum concentration above a therapeutic minimum and below toxic levels. Many drugs reach their full potential effectiveness only through precise delivery over extended periods of time.

In animal husbandry the administration of drugs to animals involves a great deal of handling which is laborious for the handler and stressful for the animals. Often animals must be brought in from long distances making prolonged or frequent treatment difficult if not prohibitive. In some cases the stress levels caused by handling stock can impair the performance of the treatment, this is particularly true in deer. Many drugs are given in slow release capsules that can cause problems when still remaining in the animal at slaughter.

Devices for implantation or insertion require a means for releasing the substance into the body. This may be controlled diffusion or by the action of a pump. Some devices incorporating pumps use a battery as a power source linked to the pump via simple electronic circuitry. Difficulties arise when internally located devices, such as surgically implanted or intra-ruminal devices, remain in animals at slaughter.

There are many disadvantages in techniques requiring surgical implantation of substance delivery devices. The device requires surgical intervention for implantation and for removal of the device. There is limited control over dose timing and dose rate. There is no interruption of the dose or variation of the dose substance without surgical intervention. There is no indication of satisfactory operation of the device and no monitoring of physiological or other animal parameters. Substances cannot be collected from the animal. There is a wide variation in the uncontrolled rate of delivery of the substance, and the volume of material that can be delivered is limited by the size of the surgical implant.

Many drug treatments on farms require the sequential and accurately timed delivery of more than one substance to achieve the desired result. This is particularly true of hard to breed stock that require treatment with up to three hormones in a precisely timed delivery programme to effect oestrus. These types of treatment require frequent visits by the veterinarian and are therefore normally reserved for valuable stock.

Some cattle problems such as facial eczema are treated with daily drenches of minerals in low amounts. This is difficult enough with dairy or milking stock but is a particular problem for dry stock, which must be yarded each day.

WO 96/00106 discloses an implantable drug delivery pump system including a sensor, a pump controller, pumps and delivery systems, all preferably implanted within a body. The pumps deliver a controlled volume or a controlled rate of two or more substances, e.g. an agent and counter-agent, to the body, in response to a body condition sensed by the sensor, e.g. temperature, pressure or the presence of glucose or other constituents. The pumps are preferably electrically controlled and may be any conventionally known pump, e.g. piston, peristaltic or centrifugal.

WO 94/01165 discloses a medication-administering device in the form of a ‘smart’ capsule for introduction into a body cavity. The capsule is said to be particularly suited to being taken orally, but may form a suppository for taking other than orally, or may be surgically introduced to a body. The capsule casing is insoluble in body cavity fluids and contains a reservoir containing the medication which is expelled into the body cavity by a pump driven by an electrolytically-generated gas. A microprocessor controls the rate of delivery of the medication which may be varied in response to body conditions, eg pH, temperature, sound or moisture, monitored by sensors included in the capsule. An electrolytic cell co-operates with body fluids surrounding the capsule to generate electrical power to supply the microprocessor and the gas generator. The capsule may also include a radio transceiver enabling the location of the capsule to be monitored, or the operation of the capsule to be controlled, from outside the body.

The insertion of a device completely within a body cavity imposes several limitations and difficulties. The size of a device is limited by the size of the body cavity of the animal within which it is to be inserted. The dimensions of any retaining means are also limited by the size of the body cavity. The size of any batteries required, and therefore the length of time over which the device may be expected to operate, is also limited. The quantity of substance that can be delivered or collected is also limited by the dimensions of the cavity into which the device is to be inserted.

Other problems of inserted devices relate to materials which are incompatible or at least undesirable for use within an animal body: e.g. lithium batteries.

Such substance delivery devices also require a means for retaining the device within the cavity of the animal. Without a reliable retention means, the device may be expelled by the animal or may simply fall out.

A device inserted into body cavities may be subject to natural muscular actions, e.g. peristalsis, tending to expel the device. This can cause problems with retention of devices. It is therefore desirable that systems provide confirmation that they remain inserted and correctly located. Known methods of retaining devices in body cavities include compressible helical coils, flexible lobes or arms which can splay outwardly from the device once the device is inserted within the body cavity, and distensible ribs which can be distended by plunger action once the device has been inserted. When extended, the projections engage the cavity walls to assist in retention of the device.

WO 96/29025 discloses an apparatus for retaining a substance delivery device in a body cavity, eg intravaginal and intraruminal devices for domestic animals such as cows. The apparatus has multiple flexible arms which splay outwardly after insertion into a body cavity to retain the apparatus therein. The arms are said to bend without breaking in response to peristaltic waves within the cavity and to return to their fully extended position once peristaltic waves have passed. The delivery device is said in one embodiment to include a battery which powers piezo pumps, preferably three, for delivering substances contained in reservoirs, under control of a microprocessor. A possible application, in which the apparatus dispenses different doses of different hormones over predetermined times to positively define the date of oestrus, is disclosed. Also disclosed is the possibility that the microprocessor makes a determination of one or more physiological parameters monitored by one or more sensors, e.g. temperature, acidity, viscosity and odour, before controlling the timing or the amount of a delivery of a substance to the body.

NZ 207341 is a further example disclosing a device not requiring surgical insertion into a body cavity of an animal and which produces a controlled rate of release into the body, of leachable chemicals incorporated into the device. NZ 207341 discloses a device having a spine with two resiliently hinged legs biased into a splayed disposition in which the device is T-shaped. With the legs folded together, the device may be inserted into the body cavity. A coating on the spine incorporates a chemical which leaches out when exposed to body fluids.

In devices employing outwardly-extending finger-like projections to engage the walls of a body cavity, the projections can interfere with the flow of normal body secretions. Where a device is implanted in a vaginal cavity, the projections can impair the flow of vaginal mucous. The fingers operate by pressing outwardly on the vaginal walls, holding them apart. This impairs the normal peristaltic action, retarding the normal mucous flow, and provides a void which allows an undesirable build-up of mucous around the device. The build-up of mucous often becomes infected and can interfere with the release of therapeutic material from the device and its uptake by the body.

In WO93/02634 there is described a device for artificial insemination of sows. The device is made up of a frame consisting of two hoops and a spinal column fitted over the back of a sow with a holder for a sperm tube. There is a small extension of the sperm tube extending into the vagina. The extension does not have a locator which is retained in a predetermined position within the vagina and it is possible that in the process of insemination seminal fluid in the sperm tube may well be lost or not delivered within the vagina.

In US 2002/0017250 there is described an artificial insemination device for sows. The device includes a saddle which is placed on the back of an animal and a clip which can grip the flanks of the animal. A rigid arm extends upwardly and rearwardly from the saddle, and supports a sachet containing semen, and a probe extends into the vagina of the animal. A constant pressure applicator associated with the sachet maintains the animal semen in the sachet under pressure. It can be seen that this device holds the sachet at an elevated position, meaning that it is would not be suitable for long term use on freely ambulatory field animals, as they could easily damage the sachet or device as it projects a significant distance above the body of the animal. Further, there is no provision for maintaining the probe in the animal's vagina, and it could easily be expelled with movement of the animal.

WO99/43269 describes a veterinary device for transporting fluid between a reservoir and a natural body cavity, such as an animal's vagina. The device includes a reservoir in fluid communication with a locator which passes through a natural orifice of the animal, and a securing means to secure the apparatus to the animal. The securing means includes a first strap which extends transversely around the body of the animal and a second strap which extends longitudinally rearwardly along the back of the animal and which encircles the animal's tail. A pair of tie lines assist in maintaining the locator within the orifice. However, it has been found with such tie lines that as the animal flexes its back or moves, upward pressure may be applied to the locator, which can result in chaffing in the orifice. Also described in that document is the use of adhesive pads to attach tie lines to the sides of the animal in the vicinity of the orifice. These adhesive pads are easily removed by the animal rubbing the area.

It is an object of preferred embodiments of the present invention to provide an apparatus for positioning an item in or near a natural orifice of a non-human animal which addresses some of the disadvantages outlined above, and/or which at least provides the public with a useful choice.

### SUMMARY OF THE INVENTION

In accordance with a first aspect of the present invention, there is provided an apparatus for positioning an item in or near a natural orifice of a non-human animal, including: at least one resilient rod having a first portion adapted to the shape of part of the animal's body spaced from the orifice and a second portion adapted to extend to or beyond the part of the animal's body in the region of the orifice; an anchoring arrangement to anchor the rod(s) to said part of the animal's body spaced from the orifice; and a transverse cross member, which cross member is adapted in use to be biased into contact with the animal's body in the region of the natural orifice as a result of the resilience of the rod(s).

In a preferred embodiment, the rod(s) has/have sufficient stiffness that it/they fit the shape of said part of the animal's body spaced from the orifice, but will then maintain that shape in the absence of manual shaping.

The natural orifice may be a vagina, anus, mouth, or nostril of the animal for example.

In one embodiment, the cross member may include or be attached to a sensor to sense a body condition or occurrence. The apparatus may be used for a posterior or anterior orifice of the animal. The apparatus is preferably adapted such that the second portion(s) of the rod(s) overhang a posterior region of the animal's body. The sensor is preferably configured to determine whether the animal is urinating.

The cross member may include an arrangement to dispense a substance, more preferably in response to sensing of a body condition or occurrence. In a particularly preferred embodiment, the arrangement is adapted to dispense substances such as micronutrients, diagnostic reagent, enzyme inhibitor or other substances directly into a urine stream. The arrangement may comprise a receptacle in the cross member, or may comprise a tube which is in fluid connection with a separate reservoir.

The cross member may include or be attached to a sensor to sense a body condition or occurrence, and the arrangement to dispense a substance may be configured to dispense the substance in response to sensing of the body condition or occurrence.

The apparatus may be configured to operate a pump or open a valve to dispense the substance(s) in response to sensing of the body condition or occurrence. Alternatively, the cross member may include a region which forms a venturi mixer and is configured such that the flow of the animal's urine through the venturi mixer draws the substance out of a tube or aperture which is in fluid communication with a reservoir, and mixes it with the urine.

In one embodiment, the cross member includes or is attached to a sensor to measure one or more urine properties such as conductivity, Brix (sugar levels), colour, transparency, light transmission at different frequencies, temperature, pH, or osmolarity. The apparatus is preferably configured to introduce one or more substances into or onto the animal's body or urine in response to the measurement. An electrical and/or data connection may be provided between the sensor and a data device to transmit data from the sensor. The data device may be provided in a saddle-type arrangement which sits on the back or rump of the animal, and the data device may send signals in response to the received measurements to introduce the substance(s) into or onto the animal's body or into the urine stream.

The cross member may include an arrangement to collect a substance, such as a sample of the animal's urine, which may comprise a receptacle in or carried by the cross member.

The cross member may be rigidly mounted to the rod(s), so as to not move relative to the rod(s). Alternatively, the cross member may be mounted to the rod(s) with sufficient friction that it can be manually moved to a desired position on the rod(s), but will maintain that position in the absence of further manual adjustment. Alternatively, the cross member may be an integral part of at least one rod.

The cross member may include a connecting portion which is connectable to an item for insertion into the animal's natural orifice. The item may be removable from connection with the cross member and interchangeable with another item. The cross member may form an integral part of a device for part penetration into a natural orifice of the animal, which device includes the cross member and an insertion portion which is unitary with the cross member. The cross member may extend in two mutually opposite directions transverse to said insertion portion, to form a substantially T-shaped device. Alternatively, the cross member may extend substantially in a single direction transverse to the insertion portion, to form a substantially ‘L’ shaped device. Alternatively, the cross member may form a substantially ‘U’ shaped device.

The cross member may be mounted to the rod(s) to enable the cross member and thereby an item connected thereto or the insertion portion to move relative to the rod(s) when the animal moves. In a preferred embodiment, the cross member is attached to the rod(s) by means of clip portion(s) which, in the embodiment having two rods, may be located at the ends of the cross member. The cross member is preferably removable from the rod(s). The rod(s) preferably include(s) a stopper at a lower end thereof to prevent the cross member from sliding off the end(s) of the rod(s).

The item or the insertion portion may include one or more apertures for delivery of one or more substance(s) into a cavity associated with the orifice of the animal. The item or the insertion portion, and the cross member, may be configured for receipt of fluid delivery tubing. A plurality of apertures may be provided in the item or the insertion portion to dispense fluid at different locations.

The item or the insertion portion may be configured to extract a substance from the orifice of the animal. In one embodiment, this can be achieved when the apparatus includes or is provided in combination with a pump, which pump can be operated in a delivery or extraction mode by reversing the pump. A preferred pump is of the type described in co-pending New Zealand Patent Application No. 523300.

The item or insertion portion may be configured to sense an internal body condition or occurrence.

The rod(s) is/are preferably sufficiently resilient to bias the item or the insertion portion at least partly into the animal's orifice.

The width of the cross member is preferably greater than the size of the animal's orifice, so that the cross member restrains over-penetration of the item or the insertion portion into the animal's orifice.

The anchoring arrangement may comprise a harness arrangement which engages part of the animal's body. In the embodiment in which the second portion(s) of the rod(s) is/are configured to overhang a posterior or anterior region of the animal so that the cross member is located at or near a posterior or anterior orifice of the animal, the rod(s) may be connectable to or may be provided as part of a saddle-type arrangement which sits on the animal's back or rump with the rods extending generally rearwardly or forwardly therefrom. The saddle may be of the type described in WO99/43269 for example, and may comprise one or more reservoirs for receipt of a substance to be delivered to the animal via the apparatus.

In a particularly preferred embodiment having two rods, the cross member may extend between the rods. The first portion(s) of the rods may be adapted to the shape of the animal's rump and the second portion(s) of the rods may be adapted to overhang the posterior region of the animal's body. The rods may be spaced from one another by the anchoring arrangement with sufficient spacing that the animal's tail can extend therebetween. It will be appreciated that a muzzle-type arrangement could be used to maintain the rod(s) on the snout of an animal if the device is to be used with the nose or mouth of the animal.

In accordance with a second aspect of the present invention, there is provided an apparatus for positioning an item near a posterior natural orifice of a non-human animal, including: two resilient rods each having a first portion adapted to the shape of the animal's rump and each having a second portion adapted to overhang the posterior region of the animal's body; an anchoring arrangement to anchor the rods to the back or rump of the animal's body with the rods extending generally rearwardly, and a cross member extending between the second portions of the rods in the overhanging region, the cross member including or attached to a sensor for sensing when an animal is urinating or to measure a urine property, the resiliency of the rods being such that in use the cross member and thereby the sensor is positioned adjacent the animal's body in the region of a posterior orifice.

The cross member may include an arrangement to dispense a substance. The arrangement to dispense is preferably arranged to dispense one or more substances directly into a urine stream.

The sensor may be configured for sensing whether an animal is urinating, and the apparatus may be configured to operate a pump or open a valve to dispense the substance(s) in response to sensing of urination. Alternatively, the cross member may include a region which forms a venturi mixer which is configured such that the flow of the animal's urine passing through the venturi mixer draws the substance out of a tube or aperture which is in fluid communication with a reservoir, and mixes it with the urine.

In accordance with a third aspect of the present invention, there is provided an apparatus for positioning an item in a natural orifice of a non-human animal, including: two resilient rods each having a first portion adapted to the shape of part of the animal's body spaced from the orifice and each having a second portion adapted to extend to or beyond the part of the animal's body in the region of the orifice; an anchoring arrangement to anchor the rods to said part of the animal's body spaced from the orifice; and a cross member connected to and extending between the second portions of the rods, the cross member being arranged for connection to an item to be inserted into the orifice of the animal, and enabling movement of the cross member relative to the rods in response to movement of the animal.

The item may be removable from connection with the cross member and interchangeable with another item. For example, the item may comprise a thermometer for insertion into the orifice, or may include a shaft portion for insertion into the orifice.

In accordance with a fourth aspect of the present invention, there is provided an apparatus for positioning an insertion portion of a member in a natural orifice of a non-human animal, including: two resilient rods each having a first portion adapted to the shape of part of the animal's body spaced from the orifice and each having a second portion adapted to extend to or beyond the part of the animal's body in the region of the orifice; an anchoring arrangement to anchor the rods to said part of the animal's body spaced from the orifice; and a substantially T-shaped member, which includes a transverse cross member connected to and extending between the second portions of the rods and an insertion portion for insertion into the orifice of the animal, the cross member being moveable relative to the rods in response to movement of the animal.

The invention consists in the foregoing and also envisages constructions of which the following gives examples only.

### BRIEF DESCRIPTION OF THE DRAWINGS

Preferred embodiments of the invention will now be described by way of example only and with reference to the accompanying drawings in which:

FIG. 1 is a perspective view of one embodiment of the present invention;

FIG. 2 shows the apparatus of FIG. 1 positioned on a cow;

FIG. 3 shows a preferred connector for connecting a rod to a saddle-type arrangement;

FIG. 4a shows a rear view of cross member with a connecting portion for use with the rods of FIGS. 1 and 2;

FIG. 4b shows a cross sectional view along line 4-4 of FIG. 4a and showing an item for connection to the cross member;

FIG. 5a shows a schematic rear view of one member for use with the rods of FIGS. 1 and 2;

FIG. 5b shows a schematic cross-sectional view along line 5-5 of the member of FIG. 5a;

FIG. 6 shows a schematic plan view of an alternative cross member and insertion portion for use with the rods of FIGS. 1 and 2; and

FIG. 7 shows an alternative embodiment having a single rod and a substantially ‘L’ shaped cross member and insertion portion.

### DETAILED DESCRIPTION OF PREFERRED FORMS

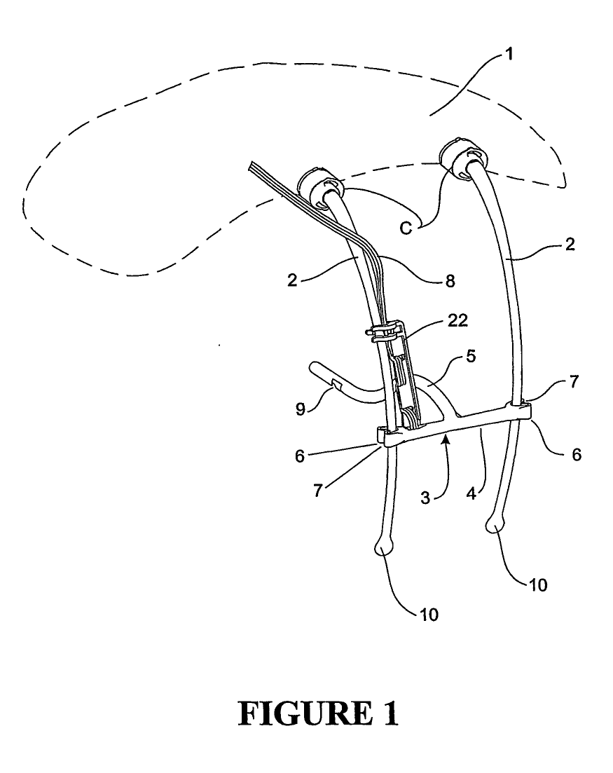

FIG. 1 illustrates one preferred form of the present invention which includes an anchoring arrangement which in this embodiment is a saddle-type arrangement 1 for placing over an animal's rump.

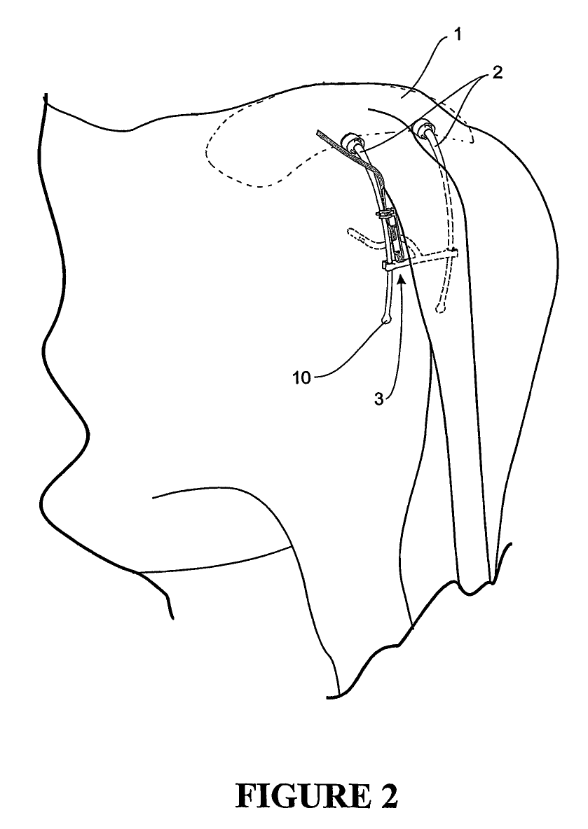

A pair of resilient rods 2 extend from the rear of the saddle 1 in a substantially parallel arrangement, and each have a first portion adapted to conform to the shape of the animal's rump as best shown in FIG. 2. In use, second portions of the rods overhang the posterior region of the animal and extend down to or past the animal's anus or vagina. The saddle 1 acts to anchor the rods 2 to the back of the animal. If necessary or desirable, the saddle can be strapped to the rump of the animal, to enhance stability. It will be appreciated that the rods could be modified to overhang or extend past an anterior orifice of the animal.

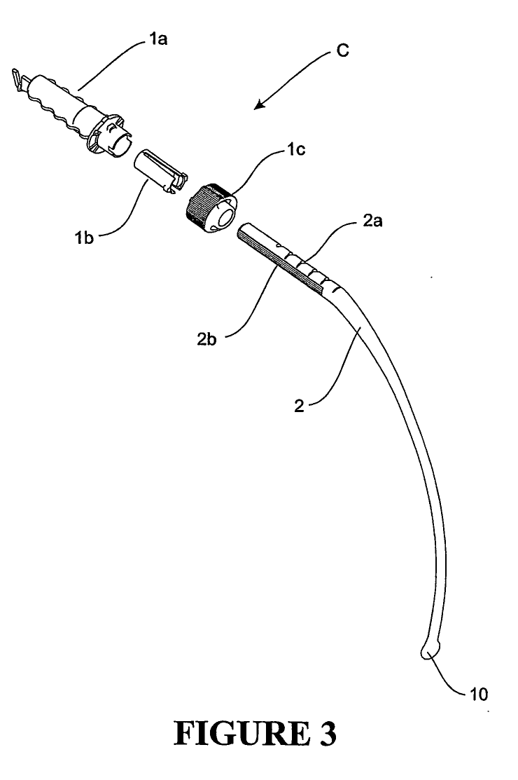

The rods 2 are preferably sufficiently stiff that they are adapted to the shape of the rump of an animal, but will then maintain that shape in the absence of manual shaping. The rods are preferably attached to the saddle-type arrangement by connectors C which will be described in more detail with reference to FIG. 3.

A substantially T-shaped member indicated generally by reference numeral 3, includes a cross member 4 and a shaft or insertion portion 5. The cross member 4 is located between the resilient rods 2 and is slidably attached thereto via clips 6 located at each end of the cross member 4. The clips define apertures 7 to house the rods 2. The cross member 4 is preferably detachable from the rods, and stops 10 are preferably provided at the lower ends of the rods to prevent downward movement of the cross member beyond the ends of the rods.

The clips 6 are a preferred means for attaching the cross member 4 to the rods 2 such that relative movement is possible, but the clips are not essential. For example, the cross member could function in the same manner with sleeves adapted to receive the rods.

The apertures 7 are preferably of a sufficient size such that there is little friction inhibiting movement of the cross member on the rods. This enables the cross member to self-adjust its vertical position on the rods according to the movement of the animal when the shaft portion is inserted in an animal's orifice.

As will be described below, whilst the shaft portion 5 and cross member 4 are shown as an integral member, they could be provided separately. The shaft portion of this embodiment is adapted to be inserted into a posterior orifice, in particular the vagina, of the animal, as is best indicated in FIG. 2. It can be seen in side view that the shaft portion 5 illustrated in FIGS. 1 and 2 is preferably of a curved shape in side view to adapt to the shape of the vaginal cavity. This assists in reducing stress to the animal, and improves retention of the shaft portion in the cavity.

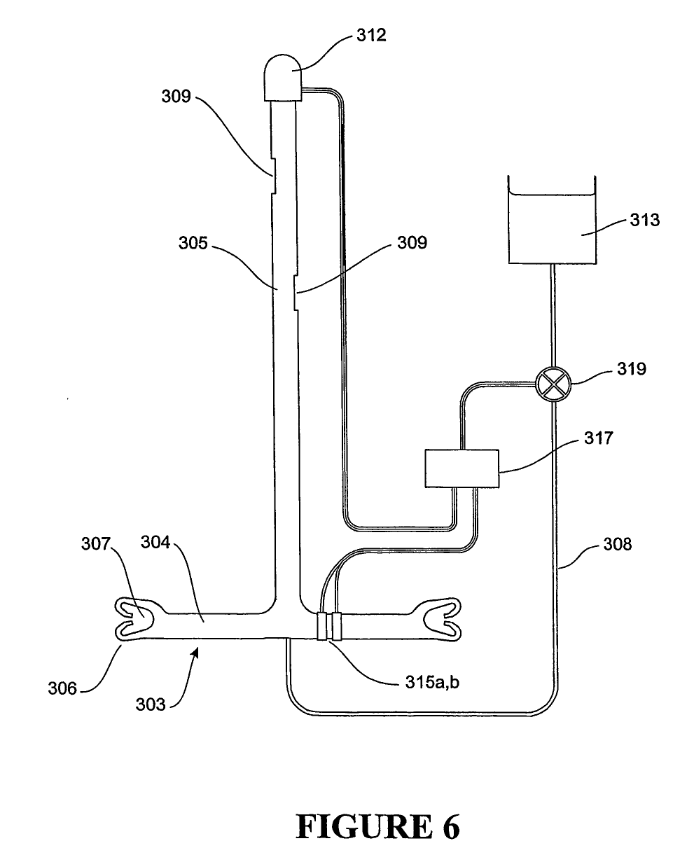

The shaft portion 5 and cross member 4 may be tubular, and define hollow cross sections which are in communication with each other to form a continuous internal channel. Alternatively, and in a preferred embodiment, a channel may be provided in the underside of the shaft portion and cross member 4, through which a tube or tubes can extend. A particularly preferred embodiment includes a number of apertures 9 (only one of which is shown in the figures) in the shaft portion for delivery of different substances into different positions within a cavity of the animal. As shown in FIG. 6, in one embodiment a sensor 312 is either attached to the shaft portion 5, or may be provided as an integral part thereof, to sense a condition or occurrence within the orifice or cavity. For example, the sensor may be configured to detect temperature within the cavity.

A conduit 8 extends between the saddle arrangement 1 and an opening 9 in the cross member 4. The conduit is configured for receipt of one or more tubes for delivery of a substance or substances to the shaft portion, and more preferably to receive one or more tubes which extend through the conduit 8, into the cross member 4 and to the aperture(s) 9 in the shaft portion 5 for dispensing of the substance(s). In the embodiment including a sensor, a wire may extend from the sensor, through the shaft portion 5, through the cross member 4, and through the conduit 8 to the saddle arrangement. The wire may be connected to a device in the saddle arrangement which records data from the sensor. In the embodiment shown, a protective shield 22 is provided to minimise or prevent damage to the conduit 8 by the animal's tail.

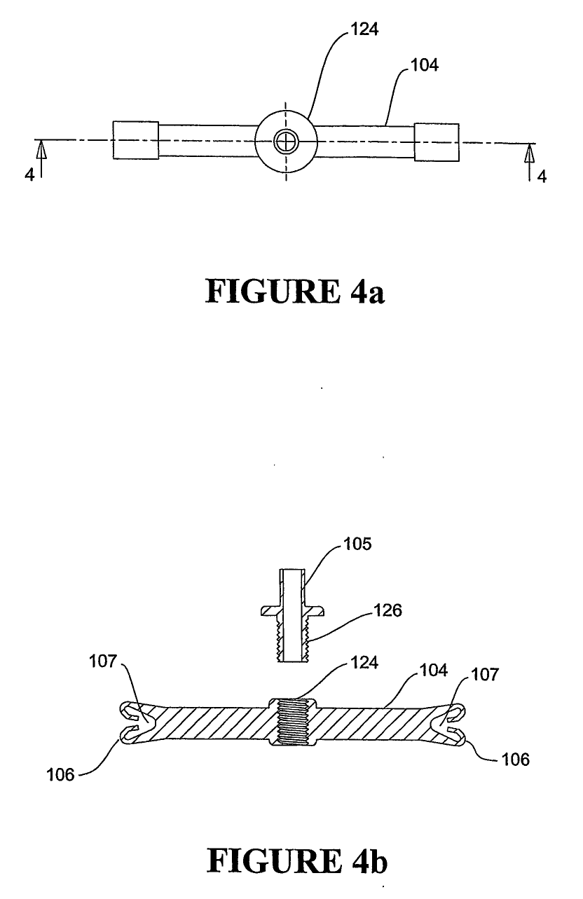

In the form illustrated in FIGS. 1 and 2, the shaft or insertion portion 5 is provided integrally with the cross member 4. However, it is also envisaged that the shaft portion may be detachable, and the cross member 4 may be configured to hold the shaft portion or another item. Such a configuration is shown in FIG. 4. In that Figure, like reference numerals are used to indicate like parts to FIGS. 1 and 2, with the addition of 100. Unless described below, the features should be considered the same as in FIGS. 1 and 2. In this embodiment, the cross member has a connecting portion 124 which preferably has a threaded aperture, configured for receipt of a threaded portion 126 of an item for insertion into an orifice of the animal. The item 126 may be an insertion portion such as described with reference to FIGS. 1 and 2. In a preferred embodiment, the item for insertion is interchangeable with another item such as a thermometer for example. The thermometer could be attached to the cross member to locate the thermometer in a desired position within the orifice. The connection between the cross member and the item may be by way of a screw thread, snap fit, or other arrangement.

In an alternative embodiment, it is not necessary to include a shaft portion or other item which is attachable to or integral with the cross member. Rather, the cross member could be used to locate a sensor against a body part of the animal, and most preferably in the urine stream of the animal. In such an embodiment, the cross member may be rigidly attached to the rod(s), as it will be appreciated that there will be no penetration by the device into an orifice of an animal to maintain the position of the cross member on the rods. Alternatively, the vertical position of the cross member relative to the rods may be manually adjusted to a desired position, but there will be sufficient friction between the rods and the cross member that the cross member will not move from the desired position in the absence of further manual adjustment. The sensor may be part of or may be attached to the cross member, and may be electrically connected to a device in the saddle arrangement as outlined above.

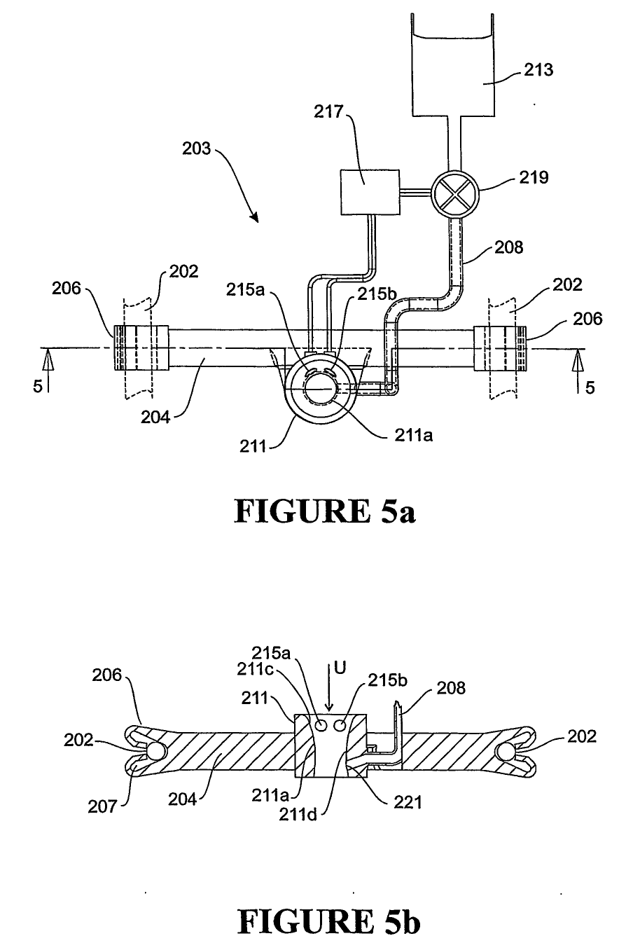

The cross member may include or be attached to a dispenser to dispense a substance into the urine stream of the animal. Two suitable arrangements for dispensing a substance into the urine stream are shown in FIG. 5 and described below. While this Figure shows two different arrangements for dispensing a substance into the urine stream, the arrangements could be used separately. Alternative dispensers may be in the form of a receptacle in or carried by the cross member, or could be a tube which is fluidly connected to the saddle arrangement in the manner outlined above. The dispenser is preferably configured to add compounds to the urine stream, to form a fertilizer. Other suitable substances include micronutrients, a diagnostic reagent or an enzyme inhibitor for example. The cross member may also include an arrangement to collect a substance, such as a sample of the animal's urine, which may comprise a receptacle in or carried by the cross member.

It will be appreciated that the sensor and/or dispenser in or attached to the cross member could be provided in an embodiment having the shaft portion 5, and which has the cross member slidable relative to the rods.

The cross member preferably includes or is attached to a sensor to measure one or more urine properties such as conductivity, Brix (sugar levels), colour, transparency, light transmission at different frequencies, temperature, pH, or osmolarity. For example, the sensor could comprise two electrodes to measure conductivity/resistance. The resistance would be infinite until urination occurs, and the resistance could be measured over time. By measuring one or more of these properties, the metabolic status of the animal can be determined. Such an arrangement could be provided either in the embodiment including a shaft portion or other item for insertion into an orifice, or can be used in the embodiment without the shaft portion.

The apparatus is preferably configured to introduce one or more substances into or onto the animal's body or into a urine stream in response to the measurement. The substance(s) may be introduced into a cavity of the animal using the shaft portion 5 or other item described above. Alternatively, the device could be configured to spray or deliver via a conduit or similar, the substance(s) onto the animal's body.

An electrical and/or data connection is provided between the cross member and a data device in the saddle arrangement described below. The apparatus is configured so that the data device sends signals in response to the received measurements to introduce the substance(s) into or onto the animal's body.

In a preferred form, the rods are moveable relative to the saddle arrangement, to provide adjustable rearward extension from the saddle arrangement. In a preferred form, a ratchet mechanism could be used to adjust the positions of the rods relative to the saddle arrangement. In an alternative form, a quick-release type mechanism could be used to adjust the positions of the rods relative to the saddle arrangement. Any other adjustable connection type could be used and is encompassed by the scope of the present invention.

A preferred form of connector C for connecting a rod 2 to the saddle-type arrangement is shown in FIG. 3. A sleeve 1a is fixed relative to the saddle type arrangement 1, and a collet 1b is positioned in the sleeve. The proximal end of the rod 2 extends into the collet. As can be seen, the rod includes a number of toothed grooves 2b running along the rod, as well as a number of annular grooves 2a. A lock nut 1c has a cam arrangement on its interior, such that the lock nut 1c is rotatable between a position in which it closes the collet 1b and a position in which it enables the collet 1b to open. When the collet 1b is open, the rods can be moved to alter the degree of penetration of the rods 2 into the saddle-type arrangement. Also, it is possible to alter the radial angle of the rods relative to the saddle-type arrangement. When the lock nut 1c is then turned, that squeezes the collet 1b closed so that a toothed portion of the collet engages with the toothed grooves 2b on the rod, thereby preventing radial angular movement of the rod relative to the saddle-type arrangement. Also, when the collet 1b is squeezed closed, the collet engages with one of the annular grooves 2b on the rod 2, thereby preventing axial movement of the proximal end of the rod 2 relative to the saddle-type arrangement. The radial grooves 2b index the penetration of the rod into the saddle-type arrangement. By allowing adjustment of the radial angles of the rods relative to the saddle-type arrangement, the rods can be arranged to hang vertically and parallel to one another to suit a wide range of animal shapes and sizes.

In the preferred form, the saddle arrangement 1 additionally or alternatively includes a fluid reservoir. The fluid reservoir may form part of the saddle arrangement or alternatively may be detachable from the saddle arrangement. A fluid transfer tube is in fluid communication with the fluid reservoir and extends through the conduit 8 into the opening 9 in the cross member 4 to transfer fluid from the fluid reservoir to the continuous internal channel of the cross member 4 and shaft portion 5. The fluid is then dispersed through an aperture 9 located in a part of the shaft portion 5 which will be located in the cavity of the animal.

In the preferred embodiment, the saddle arrangement includes three reservoirs containing different substances, which are fluidly connected to the shaft portion via three tubes extending through the conduit 8, through the channel in the cross member 4 and the shaft portion 5, and to respective apertures 9 in the shaft portion. Other numbers of reservoirs, tubes and apertures could be provided. An electronic device could be provided in or in combination with the saddle arrangement to determine when the different substances should be delivered to the animal via the shaft portion. The substances will preferably be delivered to the shaft portion via one or more pumps, such as that described in co-pending New Zealand Patent Application No. 523300. The apparatus may be configured such that the shaft portion 5 could be used to take samples from the orifice of the animal by reversing the pump.

In a more simplified from, the fluid reservoir may be attached to or integral with the cross member 4 or shaft portion 5. Such a reservoir could be in the form of a vial, test tube, or the like. The fluid is then transferred directly from the fluid reservoir to the internal channels of the cross member 4 and/or shaft portion 5 for delivery through one or more apertures located in the shaft portion.

The rods are preferably made from a resilient material such as metal or plastics for example. The shaft portion and/or cross member may be made from a plastic material such as polypropylene or acetyl for example. The preferred materials are polypropylene for example.

FIG. 5 shows two suitable arrangements for dispensing a substance into the urine stream of an animal, and unless described below the features can be considered to be the same as in FIGS. 1 and 2. Again the member 203 includes a cross member 204 which is attachable to the resilient rods via clips 206 located at each end of the cross member 204. The member 203 shown does not include an insertion portion 105 for insertion into a natural orifice of the animal, although it should be appreciated that could be provided if desired. As no insertion portion is provided, the friction of the clip portions 206 on the rods will be sufficient that that cross member can only be manually moved relative to the rods. It may be useful to provide an insertion portion and a cross member which is movable relative to the rods, to assist in positioning the venturi mixer described below in the animal's urine stream.

The member has a region 211 forming a venturi mixer as will be described below. The region includes an aperture 211a which is transverse to the rods, and is substantially aligned in use with the animal's vagina. A tube 208 extends from a fluid reservoir 213 to a position adjacent the aperture 211a. A sensor is positioned adjacent or in the aperture 211a, which in this embodiment is defined by a pair of contacts 215a, 215b positioned in the aperture 211a. In use, the cross member 204 is configured to be located in a position adjacent the animal's body such that urine will flow through the aperture 211a when the animal urinates.

The two wires from the contacts 215a, 215b form an open circuit with a controller 217 for a valve 219, which selectively blocks off fluid communication between the fluid reservoir 213 and the end of the tube 208 adjacent the aperture 21la. The controller 217, valve 219 and reservoir 213 may be provided in a back pack type arrangement for example.

When an animal urinates, the urine closes the circuit between the two contacts 215a, 215b, which triggers the controller 217 to open the valve 219, thereby allowing fluid to pass from the reservoir 213 through the tube 208. Due to the positioning of the end of the tube in the aperture 211a, fluid from the reservoir will be delivered directly into the urine stream of the animal.

It will be appreciated that modifications can be made to this embodiment. For example, rather than using a valve 219, a pump could be provided which is actuated when the circuit formed by the sensors 215 is closed as the animal urinates. A similar configuration could be used with the pump configured to operate in reverse, such that as the animal urinates, the pump sucks urine through the tube and delivers the urine to the reservoir to collect samples. Different types of sensors could be used.

It will be appreciated that it is not necessary to provide a pump, as the substance could be gravity fed. Further, in some applications it may be desirable to provide neither a pump nor a valve, but rather the substance could be constantly dispensed under the influence of gravity. It may be desirable in such an application to have a tube opening or restriction which is variable and controlled to control the dispensing rate of the substance.

The Figure also shows another suitable arrangement for dispensing a substance into the urine stream of an animal which can be used in combination with the contacts 215a, 215b or could be used alone.

It can be seen that the aperture 211a has an enlarged opening which will generally be positioned in contact with or close to the animal's body, followed by tapering wall portions 211c which form a narrowed region 211d of a waisted venturi. The tube 208 is in fluid communication with an aperture 221 in the wall of the aperture 211a.

This configuration avoids the need for sensors, valves or pumps to control the delivery of substance into the animal's urine. Instead, the diameter of the aperture 221 is selected depending on the particular substance to be delivered, such that the surface tension of the substance will hold it within the tube.

The aperture 211a forms a venturi mixer, and due to the reduced cross sectional area between the wall portions 211c in the narrowed region 211d, the flow of urine U passing through that region will travel at a greater velocity and lower pressure through the region distal from the animal's body than the region closest to the animal's body. The urine travelling at greater velocity and reduced pressure will cause the substance in the aperture 221 to be drawn out of the tube 208 and mixed with the animal's urine.

The embodiment shown will only deliver the substance into the urine when the contacts 215a, 215b sense the urination and the urine flow travels through the venturi mixer. As mentioned above, those features could be used independently.

The shape of the venturi mixer exit can be designed to cause the urine stream to split or spray as it exits. The mixer could be fitted with an impeller that is connected to a pump unit that would pump a substance out of the reservoir when it was forced to spin during urination. The impeller could also be fitted with a coil held in a magnetic field, such that when the impeller is spinning during urination, a current would be generated that could be detected with a simple electronic circuit.

Suitable substances for delivery to the urine stream by the embodiments of FIG. 5 include, but are not limited to, selenium which forms a fertilizer for the ground, enzyme inhibitors, or a reagent such as one or more of the group consisting of phenolphthalein, methyl orange, litmus, bromothymol blue or a universal indicator to measure or indicate pH via a colour change. In the latter example, the member could be provided with means to also collect urine after mixing to electronically measure any change induced by adding the reagent; such as a change in colour or conductivity. This analysis can all take place automatically on the cow in real time or be collected and stored for later analysis.

FIG. 6 shows suitable sensors on a member 303 for use with the rods of FIGS. 1 and 2, and like reference numerals indicate like parts with the addition of 300. The features should be considered the same as FIGS. 1 and 2 unless described below. In this embodiment, the cross member 304 includes a pair of sensors 315a, 315b which could be configured in a similar manner to FIG. 5 to determine when the animal is urinating. Alternatively, one or more sensors could be positioned on the cross member to detect one or more occurrences or properties. A sensor 312 is also provided on the insertion portion 305, which sensor 312 could be a thermocouple, oxygen sensor, microphone, etc. In this embodiment, the internal sensor 312 and the external sensors 315a, 315b are configured to send signals to a controller 317, which is programmed to deliver one or more substance(s) via tube 308 into a cavity associated with the orifice of the animal, when the readings match a predetermined setting.

The above describes preferred forms of the invention and any modifications made thereto without departing from the scope of the invention.

For example, rather than providing the rods with a saddle arrangement, the rods may simply be maintained in position on the animal by a belt, brackets, ties or the like. In such an embodiment, the fluid reservoir and/or data device as applicable could be provided as an integral part of the cross member or shaft portion, or may be provided as separate items.

The preferred embodiment is shown in a particular configuration for use with a cow. It will be appreciated that the device is adaptable for use with other non-human animals including but not limited to sheep, deer, pigs and horses. The preferred embodiment is also shown with the shaft portion arranged for insertion into a vagina It will be appreciated that the device can be used for inserting or maintaining an item in or near another natural orifice of an animal, such as an anus, mouth or nostril. For example, a rod or rods could be configured to overhang an animal's head or snout, and hang down to or past the nostrils of the animal, with a shaft portion or item extending into the nostril. Again by providing for vertical movement between the item and rod(s), stress and chaffing will be reduced.

The preferred embodiment is shown as having a pair or resilient rods. That is not essential, however, and the apparatus may be provided with a single resilient rod.

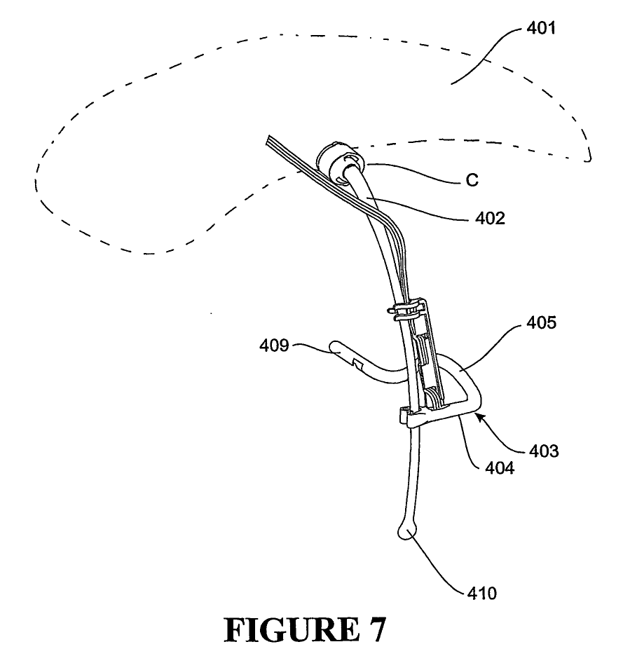

Such a configuration is shown in FIG. 7. That embodiment has a single rod 402, and a substantially ‘L’ shaped member 403 having a cross member 404 and an insertion portion 405. The rod 402 still serves to maintain the cross member 404 in contact with the animal's body, and in the embodiment with an insertion portion 405 or other item for insertion into the orifice, maintain the insertion portion or item in the orifice.

As an alternative example, the single rod could have a rigidly mounted cross member which is held against the animal's body in the region of the animal's vagina to sense when urination occurs. As another example, a device having a substantially T-shaped cross member and shaft portion could be slidably mounted to the rod approximately at the intersection of the shaft portion and cross member, to maintain the shaft portion within the cavity and the cross member against the animal's body. The substantially L-shaped device with a shaft portion and cross member extending from one side of the shaft portion could also be slidably attached to a single rod, as an alternative in the region of the intersection of the shaft portion and cross member.

For additional stability, the apparatus could be provided with more than two rods.

It will be appreciated that the rods need not be substantially circular in cross section as shown, although that is the preferred embodiment. Rather, the rods could be substantially flat members, could be elliptical, or could be other polygonal cross-sectional shapes for example.

Rather than using clips as shown, the ends of the cross member could be fitted or formed with a simple one way snap connector into which the rod shaft is pushed into place. Alternatively the cross member could be fitted or formed with holes on the ends through which the rods are threaded before connecting the proximal end of the rod to the saddle-type arrangement. In such an embodiment it will be appreciated that the distal end of the rods will not pass through the holes.

The preferred embodiments shown and described provide a number of advantages.

The preferred embodiments shown and described enable an item to be positioned in or near a natural orifice of a non-human animal, to take readings or deliver or extract substances as required, and in particular when the animal is in the field.

In the embodiment in which the cross member is mounted to a rod(s) such that it can move relative to the rods with movement of the animal, and which has a shaft or insertion portion or item for insertion into the orifice, the apparatus maintains the shaft portion or item in the orifice but enables vertical movement of the shaft portion or item relative to the rod(s), which allows the device to move with movement or back straining of the animal. This allows the animal to have a greater degree of comfort and reduces chaffing in the orifice or associated cavity, which minimises the likelihood of infection and enables the device to be maintained in the orifice for a longer period than would otherwise be possible.

The vertical movement of the cross member relative to the rod(s) reduces stress and the likelihood of breakage of the apparatus that may occur if a shaft portion is held in a fixed position on the rods.

In the embodiment having only the cross member, the resiliency of the rod(s) maintains the cross member in a desired position against the body of the animal. In the embodiment in which the cross member is not movable relative to the rod(s), such as when no insertion portion is provided, the cross member may be formed as a unitary part of one or both of the rods—for example by having a bend in the overhanging part of one or both of the rods. Further, the rods could be bent at their lower ends to maintain a sliding cross member on the rods.

1. An apparatus for positioning an item in or near a natural orifice of a non-human animal, comprising: at least one resilient rod having a first portion adapted to the shape of part of the animal's body spaced from the orifice and a second portion adapted to extend to or beyond the part of the animal's body in the region of the orifice; an anchoring arrangement to anchor the rod (s) to said part of the animal's body spaced from the orifice; and a transverse cross member, which cross member is adapted in use to be biased into contact with the animal's body in the region of the natural orifice as a result of the resilience of the rod (s).

2. An apparatus as claimed in claim 1, wherein the rod(s) has/have sufficient stiffness that it/they fit the shape of said part of the animal's body spaced from the orifice, but will then maintain that shape in the absence of manual shaping.

3. An apparatus as claimed in claim 1, wherein the cross member comprises or is attached to a sensor to sense a body condition or occurrence.

4. An apparatus as claimed in claim 3, wherein the apparatus is adapted such that the second portion (s) of the rod (s) overhang (s) a posterior region of the animal's body.

5. An apparatus as claimed in claim 4, wherein the sensor is configured to determine whether the animal is urinating.

6. An apparatus as claimed in claim 1, wherein the cross member comprises an arrangement to dispense a substance.

7. An apparatus as claimed in claim 6, wherein the arrangement to dispense comprises a receptacle in the cross member or a tube which is in fluid connection with a separate reservoir.

8. An apparatus as claimed in claim 6, wherein the cross member comprises or is attached to a sensor to sense a body condition or occurrence, and the arrangement to dispense a substance is configured to dispense the substance in response to sensing of the body condition or occurrence.

9. An apparatus as claimed in claim 8, wherein the arrangement to dispense is adapted to dispense one or more substances directly into a urine stream.

10. An apparatus as claimed in claim 8, wherein the apparatus is configured to operate a pump or open a valve to dispense the substance (s) in response to sensing of the body condition or occurrence.

11. An apparatus as claimed in claim 6, wherein the cross member comprises a region which forms a venturi mixer and is configured such that the flow of the animal's urine through the venturi mixer draws the substance out of a tube or aperture which is in fluid communication with a reservoir, and mixes it with the urine.

12. An apparatus as claimed in claim 1 comprising or attached to a sensor which is configured to measure one or more urine properties.

13. An apparatus as claimed in claim 12, which is configured to introduce one or more substances into or onto the animal's body or urine in response to the measurement.

14. An apparatus as claimed in claim 13, wherein an electrical and/or data connection is provided between the sensor and a data device to transmit data from the sensor.

15. An apparatus as claimed in claim 14, wherein the data device is provided in a saddle-type arrangement which sits on the back or rump of the animal, and the data device is configured to send signals in response to the received measurements to introduce the substance (s) into or onto the animal's body or into the urine stream.

16. An apparatus as claimed in claim 1, wherein the cross member comprises an arrangement to collect a substance from the animal.

17. An apparatus as claimed in claim 16, wherein the arrangement comprises a receptacle in or carried by the cross member.

18. An apparatus as claimed in claim 1, wherein the cross member is rigidly mounted to the rod (s), so as to not move relative to the rod (s).

19. An apparatus as claimed in claim 1, wherein the cross member is mounted to the rod (s) with sufficient friction that it can be manually moved to a desired position on the rod (s), but will maintain that position in the absence of further manual adjustment.

20. An apparatus as claimed in claim 1, wherein the cross member is an integral part of at least one rod.

21. An apparatus as claimed in claim 1, wherein the cross member comprises a connecting portion which is connectable to an item for insertion into the animal's natural orifice.

22. An apparatus as claimed in claim 21, wherein the item is removable from connection with the cross member and interchangeable with another item.

23. An apparatus as claimed in claim 1, wherein the cross member forms an integral part of a device for part penetration into a natural orifice of the animal, which device comprises the cross member and an insertion portion which is unitary with the cross member.

24. An apparatus as claimed in claim 23, wherein the cross member extends in two mutually opposite directions transverse to said insertion portion, to form a substantially T-shaped device.

25. An apparatus as claimed in claim 23, wherein the cross member extends substantially in a single direction transverse to said insertion portion, to form a substantially ‘L’-shaped device.

26. An apparatus as claimed in claim 21, wherein the cross member is mounted to the rod (s) to enable the cross member and thereby an item connected thereto or the insertion portion to move relative to the rod (s) when the animal moves.

27. An apparatus as claimed in claim 26, wherein the cross member is attached to the rod (s) by means of respective clip portion (s).

28. An apparatus as claimed in claim 26, wherein the cross member is removable from the rod (s).

29. An apparatus as claimed in claim 26, wherein the or each rod comprises a stopper at a lower end thereof to prevent the cross member from sliding off the lower end (s) of the rod (s).

30. An apparatus as claimed in claim 21, wherein the item or the insertion portion comprises one or more apertures for delivery of one or more substance (s) into a cavity associated with the orifice of the animal.

31. An apparatus as claimed in claim 30, wherein the item or the insertion portion, and the cross member are configured for receipt of fluid delivery tubing.

32. An apparatus as claimed in claim 30, wherein a plurality of apertures are provided in the item or the insertion portion to dispense fluid at different locations.

33. An apparatus as claimed in claim 21, wherein the item or the insertion portion is configured to extract a substance from the orifice of the animal.

34. An apparatus as claimed in claim 33, comprising or provided in combination with a pump which can be operated in a delivery or extraction mode by reversing the pump.

35. An apparatus as claimed in claim 21, wherein the item or the insertion portion is configured to sense an internal body condition or occurrence.

36. An apparatus as claimed in claim 21, wherein the rod (s) is/are sufficiently resilient to bias the item or the insertion portion at least partly into the animal's orifice.

37. An apparatus as claimed in claim 21, wherein the width of the cross member is greater than the size of the animal's orifice, so that the cross member restrains over-penetration of the item or the insertion portion into the animal's orifice.

38. An apparatus as claimed in claim 1, wherein the anchoring arrangement comprises a harness arrangement which engages part of the animal's body.

39. An apparatus as claimed in claim 1, wherein the second portion (s) of the rod (s) is/are configured to overhang a posterior or anterior region of the animal so that the cross member is located at or near a posterior or anterior orifice of the animal, and the rod (s) is/are connectable to or is/are provided as part of a saddle-type arrangement which sits on the animal's back or rump with the rod (s) extending generally rearwardly or forwardly therefrom.

40. An apparatus as claimed in claim 1, having two said rods, with the cross member extending between the rods.

41. An apparatus as claimed in claim 1, wherein the rod (s) is/are adapted to the shape of the animal's rump and to overhang the posterior region of the animal's body.

42. An apparatus as claimed in claim 41 and having two rods, wherein the rods are spaced from one another by the anchoring arrangement with sufficient spacing that the animal's tail can extend therebetween.

43. An apparatus for positioning an item near a posterior natural orifice of a non-human animal, comprising: two resilient rods each having a first portion adapted to the shape of the animal's rump and each having a second portion adapted to overhang the posterior region of the animal's body; an anchoring arrangement to anchor the rods to the back or rump of the animal's body with the rods extending generally rearwardly; and a cross member extending between the second portions of the rods in the overhanging region, the cross member comprising or attached to a sensor for sensing when an animal is urinating or to measure a urine property, the resiliency of the rods being such that in use the cross member and thereby the sensor is positioned adjacent the animal's body in the region of a posterior orifice.

44. An apparatus as claimed in claim 43, wherein the cross member comprises an arrangement to dispense a substance.

45. An apparatus as claimed in claim 44, wherein the arrangement to dispense is arranged to dispense one or more substances directly into a urine stream.

46. An apparatus as claimed in claim 45, wherein the sensor is configured for sensing whether an animal is urinating, and the apparatus is configured to operate a pump or open a valve to dispense the substance (s) in response to sensing of urination.

47. An apparatus as claimed in claim 43, wherein the cross member comprises a region which forms a venturi mixer and is configured such that the flow of the animal's urine passing through the venturi mixer draws the substance out of a tube or aperture which is in fluid communication with a reservoir, and mixes it with the urine.

48.-50. (canceled)

51. An apparatus for positioning an item in a natural orifice of a non-human animal, comprising: two resilient rods each having a first portion adapted to the shape of part of the animal's body spaced from the orifice and each having a second portion adapted to extend to or beyond the part of the animal's body in the region of the orifice; an anchoring arrangement to anchor the rods to said part of the animal's body spaced from the orifice; and a cross member connected to and extending between the second portions of the rods, the cross member being arranged for connection to an item to be inserted into the orifice of the animal, wherein the cross member is moveable along the second portions of the rods in response to movement of the animal.

52. An apparatus as claimed in claim 51, wherein the item is removeable from connection with the cross member and interchangeable with another item.

53. An apparatus for positioning an insertion portion of a member in a natural orifice of a non-human animal, comprising: two resilient rods each having a first portion adapted to the shape of part of the animal's body spaced from the orifice and each having a second portion adapted to extend to or beyond the part of the animal's body in the region of the orifice; an anchoring arrangement to anchor the rods to said part of the animal's body spaced from the orifice; and a substantially T-shaped member, which comprises a transverse cross member connected to and extending between the second portions of the rods and an insertion portion for insertion into the orifice of the animal, wherein the cross member is moveable along the second portions of the rods in response to movement of the animal.
